(19) United States
(12) Patent Application Publication
(10) Pub. No.: US 2024/0211724 A1
(43) Pub. Date: Jun. 27, 2024

(54) MULTIPLE-MODEL HETEROGENEOUS COMPUTING

(71) Applicants: Baidu USA, LLC, Sunnyvale, CA (US); Baidu.com Times Technology (Beijing) Co., Ltd., Beijing (CN)

(72) Inventors: Haofeng KOU, Palo Alto, CA (US); Xing LI, Santa Clara, CA (US); Huimeng ZHENG, Beijing (CN); Lei WANG, Beijing (CN); Zhen CHEN, Beijing (CN)

(73) Assignees: Baidu USA LLC, Sunnyvale, CA (US); Baidu.com Times Technology (Beijing) Co., Ltd., Beijing (CN)

(21) Appl. No.: 18/556,619

(22) PCT Filed: Aug. 11, 2021
(86) PCT No.: PCT/CN2021/112129

§ 371 Date: Oct. 20, 2023

(51) Int. Cl. G06N 3/04

(52) U.S. Cl. CPC G06N 3/04

(57) ABSTRACT

Modern deep neural network (DNN) models have many layers with a single layer potentially involving large matrix multiplications. Such heavy calculation brings challenges to deploy such DNN models on a single edge device, which has relatively limited computation resources. Therefore, multiple and even heterogeneous edge devices may be required for applications with stringent latency requirements. Disclosed in the present patent documents are embodiments of a model scheduling framework that schedules multiple models on a heterogeneous platform. Multiple-model heterogeneous computing is partitioned into a neural computation optimizer (NCO) part and a neural computation accelerator (NCA) part. The migration, transition, or transformation of DNN models from cloud to edge is handled by the NCO, while the deployment of the transformed DNN models on the heterogeneous platform is handled by the NCA. Such a separation of implementation simplifies task execution and improves the flexibility for the overall framework.

### TECHNICAL FIELD

The present disclosure relates generally to systems and methods for computer learning that can provide improved computer performance, features, and uses. More particularly, the present disclosure relates to systems and methods for multiple models heterogeneous computing.

### BACKGROUND

Deep neural networks (DNNs) have achieved great successes in many domains, such as computer vision, natural language processing, recommender systems, etc. The research of DNNs has been gaining ever-increasing impetus due to their state-of-the-art performance across diverse application scenarios. Each year, a multitude of new DNN architectures are proposed for emerging intelligent services with more stringent requirements on accuracy improvement, latency reduction, privacy-preserving, energy efficiency, etc. For example, in the computer vision field, various models have been proposed for object detection recently and have been proved to surpass human-level performance. Meanwhile, researchers and domain experts are confronted with increasingly more data, richer data types, and more sophisticated data analytics, which require collaboration between diverse models under different tasks to solve challenging real-world problems. For instance, in the case of target re-identification, an abundance of advance models are developed on top of normal object detection, e.g., Simple Online Real-Time Tracking (SORT) and Deep SORT. These advanced real-time tracking models take the output of a normal object tracking model as input and compute the associated appearance descriptors within each frame to keep tracking a specific target. It is an inevitable trend that routine intelligent services call for multiple advanced DNNs models to finish complicated tasks with remarkable performance.

However, most DNNs focus on boosting accuracy at the expense of substantially increased model complexity. The depth of the current state-of-the-art networks may reach dozens or even hundreds of layers to outperform previous networks for related tasks in terms of accuracy. A single layer may require millions of matrix multiplications. Such heavy calculation brings challenges for deploying these DNN models on a single edge device with limited computation resources.

Accordingly, what is needed are systems, devices and methods that address the above-described issues for model deployment in various platforms with limited computation resources.

### SUMMARY

Embodiments of the present disclose provide a computer-implemented method for multi-model implementation, a system for multi-model implementation, a non-transitory computer-readable medium or media.

According to a first aspect, some embodiments of the present disclosure provide a computer-implemented method for multi-model implementation. The method includes: transforming, by a neural computing optimizer (NCO), each of multiple neural network models into a hardware-specific format that fits in a heterogeneous hardware platform; establishing, a model tree for the transformed multiple neural network models to represent a collaborative relationship among the transformed multiple neural network models for implementation in the heterogeneous hardware platform; mapping, by a neural computing accelerator (NCA), the model tree into the heterogeneous hardware platform for deployment; and scheduling, by the NCA, one or more transformed neural network models for action using corresponding mapped resources in the heterogeneous hardware platform.

According to a second aspect, some embodiments of the present disclosure provide a system for multi-model implementation. The system includes: a neural computing optimizer (NCO) that transforms each of multiple neural network models into a hardware-specific format fitting in a heterogeneous hardware platform, the transformed multiple neural network models are represented in a model tree for a collaborative relationship for execution in the heterogeneous hardware platform; and a neural computing accelerator (NCA) that maps the model tree into the heterogeneous hardware platform and schedules one or more transformed neural network models for operation in the heterogeneous hardware platform.

According to a third aspect, some embodiments of the present disclosure provide a non-transitory computer-readable medium or media. The non-transitory computer-readable medium or media includes one or more sequences of instructions which, when executed by at least one processor, causes steps for multi-model implementation comprising: transforming, by a neural computing optimizer (NCO), each of multiple neural network models into a hardware-specific format that fits in a heterogeneous hardware platform; establishing, a model tree for the transformed multiple neural network models to represent a collaborative relationship among the transformed multiple neural network models for implementation in the heterogeneous hardware platform; mapping, by a neural computing accelerator (NCA), the model tree into the heterogeneous hardware platform for deployment; and scheduling, by the NCA, one or more transformed neural network models for action using corresponding mapped resources in the heterogeneous hardware platform.

### BRIEF DESCRIPTION OF THE DRAWINGS

References will be made to embodiments of the disclosure, examples of which may be illustrated in the accompanying figures. These figures are intended to be illustrative, not limiting. Although the disclosure is generally described in the context of these embodiments, it should be understood that it is not intended to limit the scope of the disclosure to these particular embodiments. Items in the figures may not be to scale.

FIG. 1 depicts a model scheduling framework for multiple-model heterogeneous computing, according to embodiments of the present disclosure.

FIG. 2 depicts a flow process for model transforming performed by a neural computing optimizer (NCO), according to embodiments of the present disclosure.

FIG. 3 depicts multiple DNN models for heterogeneous computing, according to embodiments of the present disclosure.

FIG. 4 depicts a heterogeneous hardware platform for heterogeneous computing, according to embodiments of the present disclosure.

FIG. 5 depicts a process for multiple-model heterogeneous computing, according to embodiments of the present disclosure.

FIG. 6 depicts a process for vision processing unit (VPU) allocation, according to embodiments of the present disclosure.

FIG. 7 graphically depicts a pipeline of tasks for action using corresponding models, according to embodiments of the present disclosure.

FIG. 8 depicts a simplified block diagram of a computing device/information handling system, according to embodiments of the present disclosure.

### DETAILED DESCRIPTION OF EMBODIMENTS

In the following description, for purposes of explanation, specific details are set forth in order to provide an understanding of the disclosure. It will be apparent, however, to one skilled in the art that the disclosure can be practiced without these details. Furthermore, one skilled in the art will recognize that embodiments of the present disclosure, described below, may be implemented in a variety of ways, such as a process, an apparatus, a system, a device, or a method on a tangible computer-readable medium.

Components, or modules, shown in diagrams are illustrative of exemplary embodiments of the disclosure and are meant to avoid obscuring the disclosure. It shall be understood that throughout this discussion that components may be described as separate functional units, which may comprise sub-units, but those skilled in the art will recognize that various components, or portions thereof, may be divided into separate components or may be integrated together, including, for example, being in a single system or component. It should be noted that functions or operations discussed herein may be implemented as components. Components may be implemented in software, hardware, or a combination thereof.

Furthermore, connections between components or systems within the figures are not intended to be limited to direct connections. Rather, data between these components may be modified, re-formatted, or otherwise changed by intermediary components. Also, additional or fewer connections may be used. It shall also be noted that the terms “coupled,” “connected,” “communicatively coupled,” “interfacing,” “interface,” or any of their derivatives shall be understood to include direct connections, indirect connections through one or more intermediary devices, and wireless connections. It shall also be noted that any communication, such as a signal, response, reply, acknowledgement, message, query, etc., may comprise one or more exchanges of information.

Reference in the specification to “one or more embodiments,” “preferred embodiment,” “an embodiment,” “embodiments,” or the like means that a particular feature, structure, characteristic, or function described in connection with the embodiment is included in at least one embodiment of the disclosure and may be in more than one embodiment. Also, the appearances of the above-noted phrases in various places in the specification are not necessarily all referring to the same embodiment or embodiments.

The use of certain terms in various places in the specification is for illustration and should not be construed as limiting. A service, function, or resource is not limited to a single service, function, or resource; usage of these terms may refer to a grouping of related services, functions, or resources, which may be distributed or aggregated. The terms “include,” “including,” “comprise,” “comprising,” or any of their variants shall be understood to be open terms and any lists that follow are examples and not meant to be limited to the listed items. A “layer” may comprise one or more operations. The words “optimal,” “optimize,” “optimization,” and the like refer to an improvement of an outcome or a process and do not require that the specified outcome or process has achieved an “optimal” or peak state. The use of memory, database, information base, data store, tables, hardware, cache, and the like may be used herein to refer to system component or components into which information may be entered or otherwise recorded.

In one or more embodiments, a stop condition may include: (1) a set number of iterations have been performed; (2) an amount of processing time has been reached; (3) convergence (e.g., the difference between consecutive iterations is less than a first threshold value); (4) divergence (e.g., the performance deteriorates); (5) an acceptable outcome has been reached; and (6) all of the data has been processed.

One skilled in the art shall recognize that: (1) certain steps may optionally be performed; (2) steps may not be limited to the specific order set forth herein; (3) certain steps may be performed in different orders; and (4) certain steps may be done concurrently.

Any headings used herein are for organizational purposes only and shall not be used to limit the scope of the description or the claims. Each reference/document mentioned in this patent document is incorporated by reference herein in its entirety.

It shall be noted that any experiments and results provided herein are provided by way of illustration and were performed under specific conditions using a specific embodiment or embodiments; accordingly, neither these experiments nor their results shall be used to limit the scope of the disclosure of the current patent document.

### A. General Introduction

Modern DNNs may have dozens or even hundreds of layers, with a single layer potentially involving millions of matrix multiplications. Such heavy calculation brings challenges for deploying such DNN models on a single edge device, which has relatively limited computational resources. Therefore, multiple and even heterogeneous edge devices may be required for the AI-driven applications with stringent latency requirements, which leads to the prevalent many-to-many problem (multi-models to heterogeneous edge devices) in real-world applications.

However, different types of hardware platforms (e.g., personal computers, smartphones, and Internet of Things (IoT) devices) usually have their own limitations and computation capacities, e.g., memory footprints and floating-point operations per second (FLOPS). If a single neural network model is deployed on an inappropriate edge device, its inference time may exceed an order of magnitude than a designed interval. Besides, due to differences in hardware and device drivers, even two edge devices with similar overall speeds (e.g., CPUs from different manufacturers) may not be able to support the same DNN model or may have significant differences in performance. Furthermore, there might be a non-negligible relationship between DNN models in the real-world applications. Multiple DNNs may need to work collaboratively for a real-world artificial intelligence (AI)-based service. For example, the output of one DNN might be the input of another DNN model for the next steps of analysis. Such collaboration brings extra challenges for model scheduling among heterogeneous edge devices. It may therefore be important to ensure that collaborative DNN models are deployed and executed concurrently (or in other desirable collective manner) and effectively on heterogeneous edge devices.

Disclosed in the present patent documents are embodiments of a model scheduling framework that may schedule a group of models on the heterogeneous platforms to not only solve the open issues but also improve the overall inference speed.

### B. Embodiments of a Model Scheduling Framework

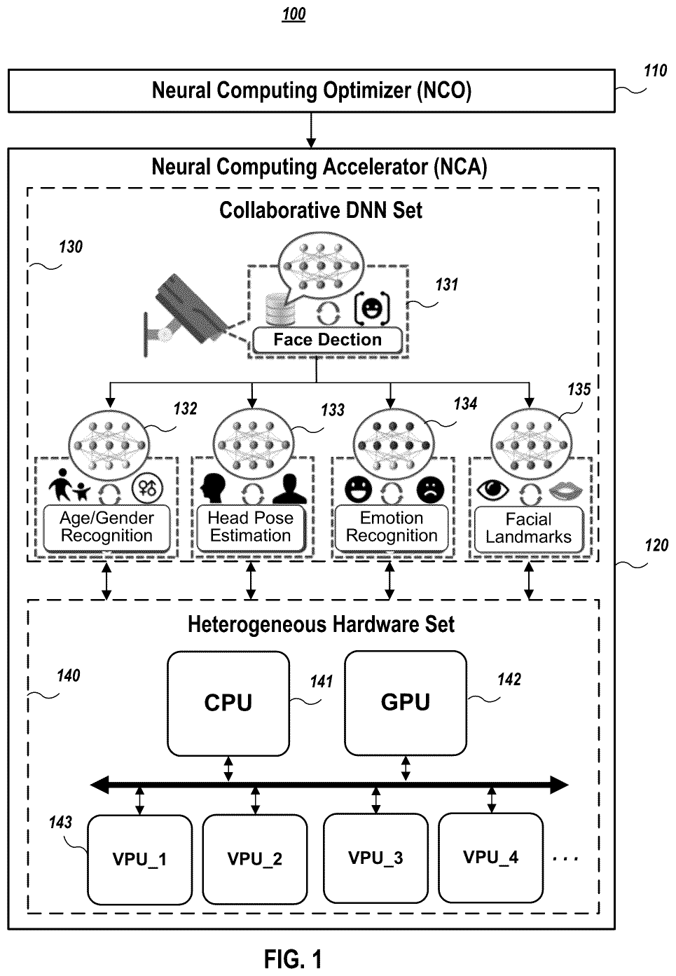

FIG. 1 depicts a model scheduling framework for multiple-model heterogeneous computing, according to embodiments of the present disclosure. The model scheduling framework comprises an NCO 110 and a Neural Computing Accelerator (NCA) 120. The NCO 110 performs operations comprising at least transforming each of multiple collaborative DNN models 130 into a hardware-specific format so that each DNN model may fit a given hardware platform, such as an edge device, which may have limited computational resources (memory, processing ability, speed, power, etc.) relative to a cloud deployment. The NCA 120 schedules execution of the multiple collaborative DNN models 130 in a context of the heterogeneous hardware platform 140 through a flexible container (or other related) approach.

In one or more embodiments, the operations performed by the NCO 110 further comprise training and optimizing each DNN model for desired performance. The training and optimization may be done on cloud with more computation resources, e.g., more memory space and faster processors, compared to the given hardware platform to which the transformed DNN model is fitted. In one or more embodiments, the NCO may be a software module in a device (e.g., an edge server, a workstation, etc.) separate from the heterogeneous hardware platform, or a computational device loaded with software or firmware for DNN model training, optimizing, and/or transformation. The NCO may couple to the heterogeneous hardware platform 140 to access platform configurations or specifications, or be preloaded with information of those platform configurations or specifications. In one or more embodiments, the NCA may be a software module, a computational device (e.g., an edge server, a workstation, etc.), or a combination thereof, operating as an administrator or a controller of the heterogeneous hardware platform 140 for resource allocation (for model deployment) and action scheduling and coordinating (for model execution).

For example, if a DNN model is trained and optimized in a cloud server with a 64-bit operating system, while the given hardware platform is running a 32-bit system, the NCO 110 may need to transform at least some of the data format in the trained DNN model from 64-bit format into 32-bit format during the transforming process. In another example, if a DNN model is trained and optimized in a cloud server having a large cache capable of handling a large data block, while the given hardware platform may have a relatively smaller cache not sufficient to handle the same size of data block, the NCO 110 may need to segment a data block into multiple “smaller” data blocks. In yet another example, a DNN model may be trained and optimized in a cloud server capable of supporting multiple threads of parallel computation, while the given hardware platform may only support smaller numbers of threads for parallel computation. The NCO 110 may need to reduce the number of threads for parallel computation when scheduling parallel computation tasks. In yet another example, if a DNN model is trained in cloud with Caffe/TensorFlow/Paddle-Paddle framework, while the given hardware platform does not support such framework but has its own embedded framework, the NCO 110 may need to transfer the DNN models' format as the format supported by the embedded framework of the given hardware platform.

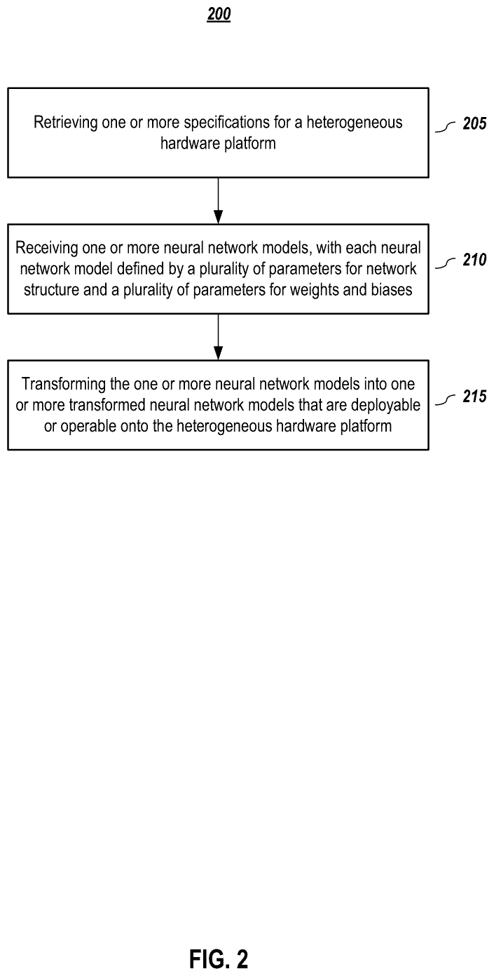

NCO is responsible for training, optimizing, and transforming DNN models into a hardware-specific format so that the model can fit a given hardware platform well. In one or more embodiments, the NCO comprises methods, e.g., Open Visual Inference and Neural network Optimization (OpenVINO), to convert DNN models that have been trained from different machine learning frameworks, e.g., TensorFLow, Caffe, PyTorch, Open Neural Network Exchange (ONNX), etc. FIG. 2 depicts a flow process for model transforming performed by an NCO, according to embodiments of the present disclosure. In step 205, the NCO retrieves one or more specifications for a heterogeneous hardware platform, e.g., operating system bitesize of the platform, processor specifications, etc. In step 210, the NCO receives one or more neural network models, which may be trained using different machine learning frameworks, with each neural network model defined by a plurality of parameters for network structure and a plurality of parameters for weights and biases. In step 215, the NCO transforms the one or more neural network models into one or more transformed neural network models that are deployable or operable onto the heterogeneous hardware platform. In one or more embodiments, the one or more transformed neural network models are presented in a unified intermediate representation (IR) format comprising two files defining each transformed neural network model. The first file is an Extensible Markup Language (XML) file containing structure parameters of the transformed neural network model. The second file is a binary (bin) file containing weights and biases of the transformed neural network model.

Referring back to FIG. 1, the multiple-model heterogeneous computing is partitioned into an NCO part and an NCA part. In one or more embodiments, the migration, transition, or transformation of DNN models from cloud to edge is handled by NCO, while the deployment of the transformed DNN models on the heterogeneous platform is handled by the NCA. Such a separation of implementation simplifies task execution and improves the flexibility for the overall framework.

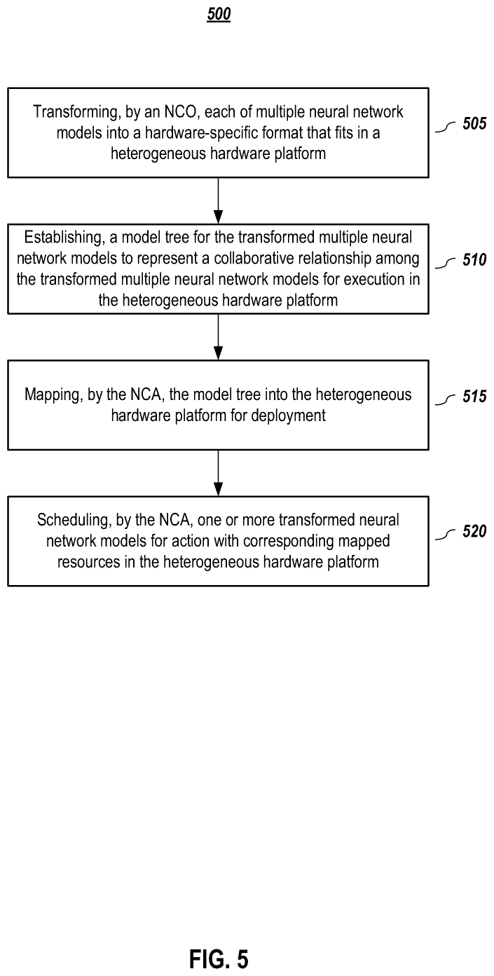

In one or more embodiments, the NCA implements operations of resource allocation, model scheduling, and model execution in the context of the heterogeneous hardware environment. Some exemplary embodiments of NCA operations are described with respect to FIGS. 5-7 and corresponding descriptions. In one or more embodiments, the NCA receives outputs from the NCO (e.g., the XML file and the bin file respectively containing structure parameters and weights/biases of each transformed neural network model), allocates resource for model deployment and schedules one or more deployed neural network models for inference in a pipeline, which may be application dependent. In one or more embodiments, the NCA contains algorithms, e.g., OpenVINO Inference Engine, to support accelerated operation of deep learning models at a hardware instruction set level. The NCA may be configured to support various hardware devices, e.g., central processing units (CPU), graphics processing unit (GPU), and vision processing unit (VPU), etc.

In one or more embodiments, the multiple collaborative DNN models 130 may need to be deployed in a collaborative manner, e.g., concurrently, sequentially, hierarchically, or a combination thereof, etc. For example, the multiple collaborative DNN models 130 may comprise a first DNN model 131, a second DNN model 132, a third DNN model 133, a fourth DNN model 134, and a fifth DNN model 135, as shown in FIG. 1. The first DNN model may be positioned in the first hierarchical level, while the other four DNN models are positioned in parallel in a second hierarchical level. More details of selection and execution one of the multiple collaborative DNN models are described later in some exemplary embodiments.

In one or more embodiments, the heterogeneous hardware platform 140 is an edge device, including one or more CPUs 141, one or more GPUs 142, and one or more VPUs 143, etc. Each VPU may comprise multiple cores for digital signal processing (DSP) operation. Components in the heterogeneous hardware platform may operate e.g., in parallel, sequentially, or a combination thereof, to run one or more DNN models deployed in the heterogeneous hardware platform. In one or more embodiments, the operation of the heterogeneous hardware platform and the deployment of one or more DNN models are scheduled by the NCA.

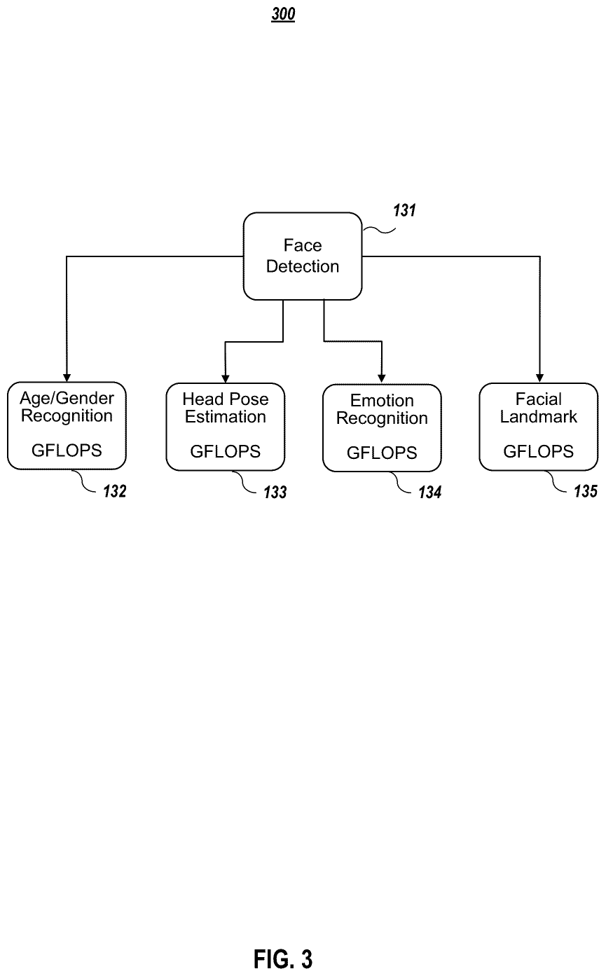

FIG. 3 depicts multiple DNN models for heterogeneous computing, according to embodiments of the present disclosure. The multiple collaborative DNN models 131-135 are all vision-based DNN models related to facial detection. There is dependency for these five DNN models that after initial detection using the first DNN model 131 for face detection, the other four DNN models may be executed. The second DNN model 132, the third DNN model 133, the fourth DNN model 134, and the fifth DNN model 135 are for age/gender recognition, head pose estimation, emotion recognition, and facial landmarks respectively.

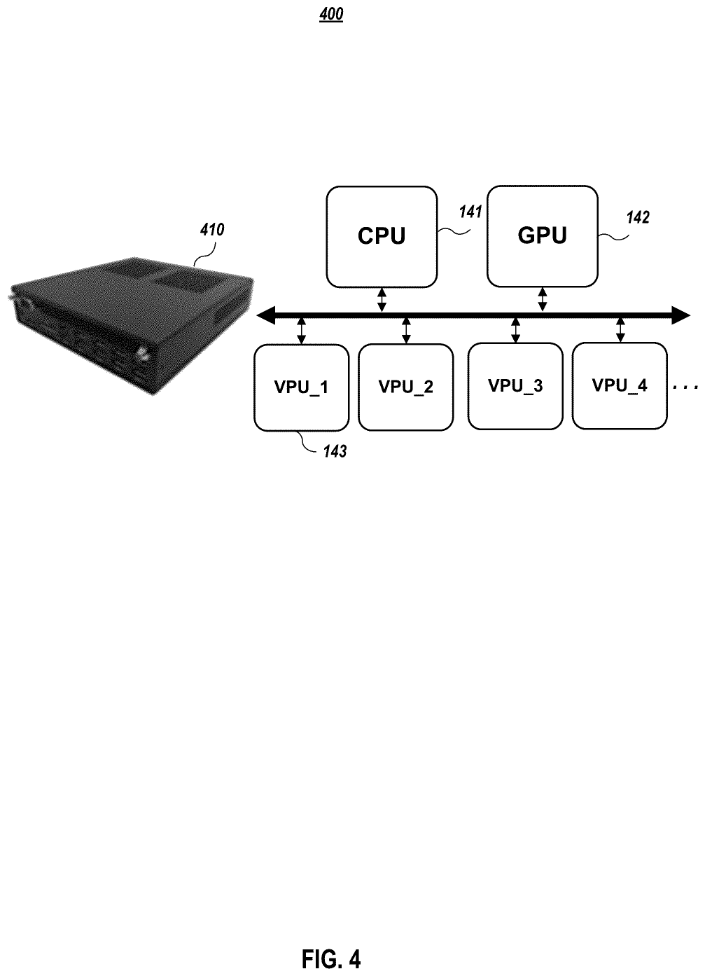

FIG. 4 depicts a heterogeneous hardware platform for heterogeneous computing, according to embodiments of the present disclosure. The heterogeneous hardware platform 140 may be an edge device 410 comprising one or more CPUs 141, one or more graphics processing units (GPUs) 142, and one or more vision processing units (VPUs) 143, etc. The heterogeneous hardware platform 140 may have a structure with the VPUs depending on the CPU(s) and GPU(s), such that the collaborative DNN models, e.g., in a model tree as shown in FIG. 3, may be mapped onto the hardware platform by the NCA.

FIG. 5 depicts a process for multiple-model heterogeneous computing, according to embodiments of the present disclosure. In step 505, the NCO transforms each of multiple neural network models, e.g., DNN models, into a hardware-specific format that fits in a heterogeneous hardware platform. In one or more embodiments, the hardware-specific format is a unified IR format comprising an XML file and a bin file respectively containing structure parameters and weights/biases of each transformed neural network model. In step 510, a model tree is established for the transformed multiple neural network models to represent a collaborative relationship among the transformed multiple neural network models for execution in the heterogeneous hardware platform. The collaborative relationship may be a concurrent, sequential, or hierarchical relationship. In step 515, the model tree is mapped, by the NCA, into the heterogeneous hardware platform for deployment. In one or more embodiments, the model tree is mapped for model deployment in view of one or more model parameters of each transformed neural network model and computation resources in the heterogeneous hardware platform for a desired resource allocation in the heterogeneous hardware platform. In step 520, the NCA schedules one or more transformed neural network models for action or implementation using corresponding mapped resources in the heterogeneous hardware platform. In one or more embodiments, the implementation of the one or more transformed neural network models is scheduled based at least on one or more triggering conditions. It shall be noted that one benefit adapting a cloud-based model to an edge computing device is that some security procedures that are needed in the cloud-based implementation (e.g., using https communications when sharing data between cloud resources) may not be required when deployed on the heterogeneous hardware platform since communications are within the same platform.

### C. Some Experiments

It shall be noted that these experiments and results are provided by way of illustration and were performed under specific conditions using a specific embodiment or embodiments; accordingly, neither these experiments nor their results shall be used to limit the scope of the disclosure of the current patent document.

Described below are exemplary embodiments of deploying multiple collaborative DNN models in a heterogeneous hardware platform. As shown in FIG. 3, these multiple collaborative DNN models 131-135 are all vision-based DNN models related to facial detection. The first DNN model 131 may be a general face detection to verify whether one or more faces are detected in an image or a video frame. The second DNN model 132, the third DNN model 133, the fourth DNN model 134, and the fifth DNN model 135 are more specific involving age/gender recognition, head pose estimation, emotion recognition, and facial landmarks respectively. Accordingly, there are dependencies for these DNN models that after an initial detection using the first DNN model 131 for face detection, the other four DNN models may be implemented. Depending upon the tree structure, these models may be implemented in parallel, sequentially, or a combination thereof.

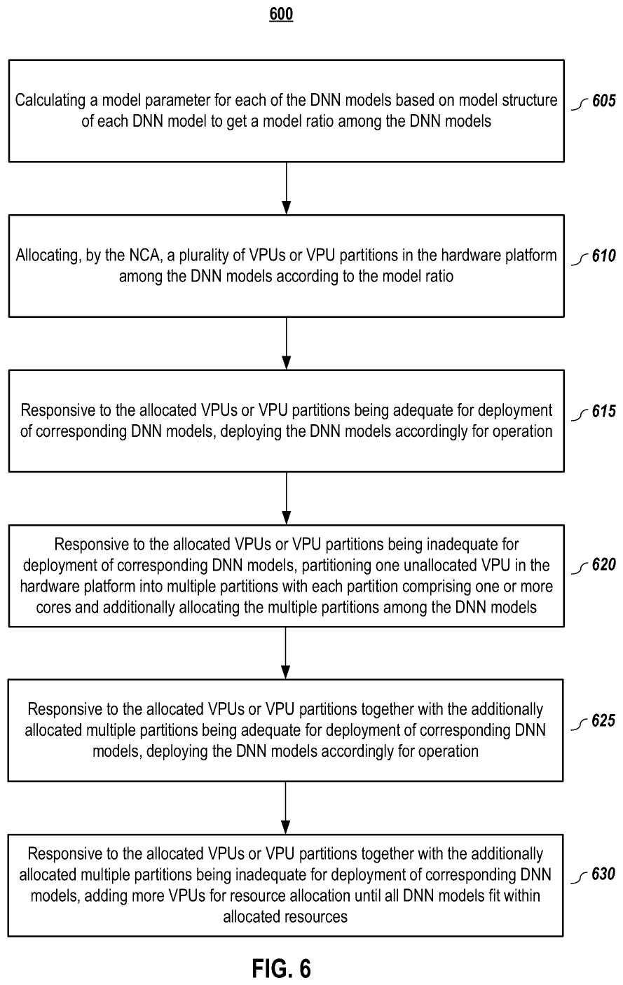

The model tree shown in FIG. 3 for face detection is mapped to a heterogeneous hardware platform as shown in FIG. 4. In one or more embodiments, the first DNN model 131 is mapped into the CPU and GPU, which are in one silicon die, while the other four DNN models are mapped onto corresponding VPUs. FIG. 6 depicts a process for VPU allocation, according to embodiments of the present disclosure. In step 605, a model parameter, e.g., Giga floating-point operations per second (GFLOPS), for each of the DNN models based on model structure of each DNN model is calculated to get a model ratio among the DNN models. The model parameter or metric may be static (e.g., memory size requirement, number of parameters, etc.) or may be dynamic (e.g., typical computation runtime). In one or more embodiments, the calculation is specifically for the DNN models at the same hierarchical level, such as the DNN models 132-135 shown in FIG. 3.

In step 610, a plurality of VPUs or VPU partitions within the hardware platform, are allocated by the NCA, among the DNN models according to the model ratio. For example, if the model ratio among the DNN models 132-135 is 1:3:2:4, the NCA allocates 10 VPUs or 10 VPU partitions initially with 1, 3, 2, and 4 VPUs respectively for the DNN models 132-135. In one or more embodiments, when the hardware platform has more than 10 VPUs, the NAC allocates 10 VPUs among the DNN models, but it may partition more to help speed processing time. When the hardware platform has less than 10 VPUs, the NCA partitions one or more VPUs for at least 10 VPU partitions and then allocates 10 VPU partitions among the DNN models, with each partition comprising one or more cores. Such a VPU or VPU partition allocation may ensure that corresponding DNN models have similar inference time with the allocated VPUs or VPU partitions.

In step 615, responsive to the allocated VPUs or VPU partitions being adequate for deployment of corresponding DNN models, the DNN models are deployed according to the allocated VPUs for operation. In one or more embodiments, the allocated VPUs or VPU partitions being adequate for deployment of corresponding DNN models is such defined that a DNN model (transformed by the NCO) is able to perform an inference using the allocated VPN(s) or VPN partitions(s) in the hardware platform within a predetermined time interval to meet a latency requirement. The inference time may be tested using a test inference performed on a test data set.

In step 620, responsive to the allocated VPUs or VPU partitions being inadequate for deployment of corresponding DNN models, at least one unallocated VPU in the hardware platform is partitioned into multiple, e.g., 2, 4, or 8, partitions with each partition comprising one or more cores. For example, a VPU may have 16 DSP cores. With 4 partitions for the VPU, each partition may have 4 cores. The multiple partitions are allocated, by the NCA, among the DNN models. In one or more embodiments, the allocation of VPU partitions are implemented with consideration of both computation resource and communication needed among the partitions. For example, 2-4 partitions may have the best performance.

In step 625, responsive to the allocated VPUs together with allocated partitions being adequate for deployment of corresponding DNN models, the DNN models are deployed accordingly for operation.

In step 630, responsive to the allocated VPUs together with allocated partitions being inadequate for deployment of corresponding DNN models, one or more VPUs, with or without VPU partitions, are added for resource allocation among the DNN models until all DNN models fit within allocated resources. The more VPUs may be added internally from existing unallocated VPUs, or externally via peripheral component interconnect express (PCIe) or USB interface.

Experiment results prove the effectiveness of the disclosed approach for model deployment for accelerating the inference speed of single and multiple AI-based services on the heterogeneous edge devices, including CPU, GPU, and VPU. Each of multiple models for face detection is configured into independent software modules with deep learning (DL) framework embedded inside a module block, which may be re-organized into different structures for different use-cases through a container (or other related approaches) which are flexible to move around for re-configuration.

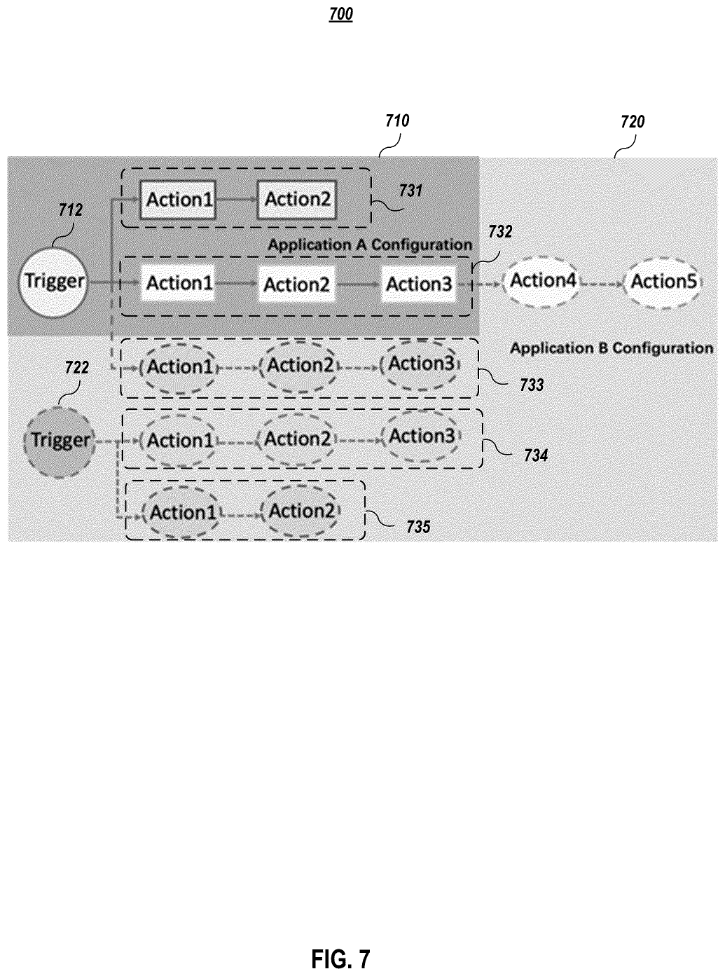

FIG. 7 graphically depicts a pipeline of tasks for action using corresponding models, according to embodiments of the present disclosure. Each action shown in FIG. 7 is performed by a corresponding DNN model. Specifically, action 1 corresponds to tasks performed by the DNN model 131 for general face detection shown in FIG. 3. Task scheduling may be initially configured as a first configuration 610 (Application A configuration), which comprises a first route 731 and a second route 732.

Depending on conditions of a first trigger 712 for application A, a task pipeline for implementation may go to the first route 731 in which action 1 performed by the DNN model 131 for general face detection followed by action 2 performed by the DNN model 132 for gender recognition, or the second route 732 in which action 1 performed by the DNN model 131 for general face detection followed by action 2 performed by the DNN model 132 for gender recognition and then action 3 performed by the DNN model 135 for facial landmarks.

In one or more embodiments, the task pipeline may be re-configured during implementation. For example, following action 3, additional actions, e.g., action 4 and action 5 performed by other DNN models, may be added in route 732 following action 3. In another example, a third route 733 involving a separate action combination may be added and associated to the first trigger 712.

In one or more embodiments, a second trigger 722 may be added besides the first trigger 721. The second trigger 722 associates with a fourth route 734 and a fifth route 735. For example, the second trigger may be related to body detection. Upon the second trigger being triggered, the task pipeline may be derived into the fourth route 734 or the fifth route, depending on body detection outcome. In one or more embodiments, all the extended actions (e.g., actions 4 and 5 in route 732) or newly added routes and its derived tasks may build up a new structure and become a second configuration 720 (Application B configuration as shown in FIG. 7).

In a short summary, the present patent disclosure provides embodiments in providing actionable insights on scheduling an efficient deployment of a group of collaborative neural network models, e.g., DNNs, among heterogeneous hardware devices and assessment of partition and scheduling processes.

### A. Computing System Embodiments

In one or more embodiments, aspects of the present patent document may be directed to, may include, or may be implemented on one or more information handling systems (or computing systems). An information handling system/computing system may include any instrumentality or aggregate of instrumentalities operable to compute, calculate, determine, classify, process, transmit, receive, retrieve, originate, route, switch, store, display, communicate, manifest, detect, record, reproduce, handle, or utilize any form of information, intelligence, or data. For example, a computing system may be or may include a personal computer (e.g., laptop), tablet computer, mobile device (e.g., personal digital assistant (PDA), smart phone, phablet, tablet, etc.), smart watch, server (e.g., blade server or rack server), a network storage device, camera, or any other suitable device and may vary in size, shape, performance, functionality, and price. The computing system may include random access memory (RAM), one or more processing resources such as a central processing unit (CPU) or hardware or software control logic, read only memory (ROM), and/or other types of memory. Additional components of the computing system may include one or more drives (e.g., hard disk drive, solid state drive, or both), one or more network ports for communicating with external devices as well as various input and output (I/O) devices, such as a keyboard, mouse, touchscreen, stylus, microphone, camera, trackpad, display, etc. The computing system may also include one or more buses operable to transmit communications between the various hardware components.

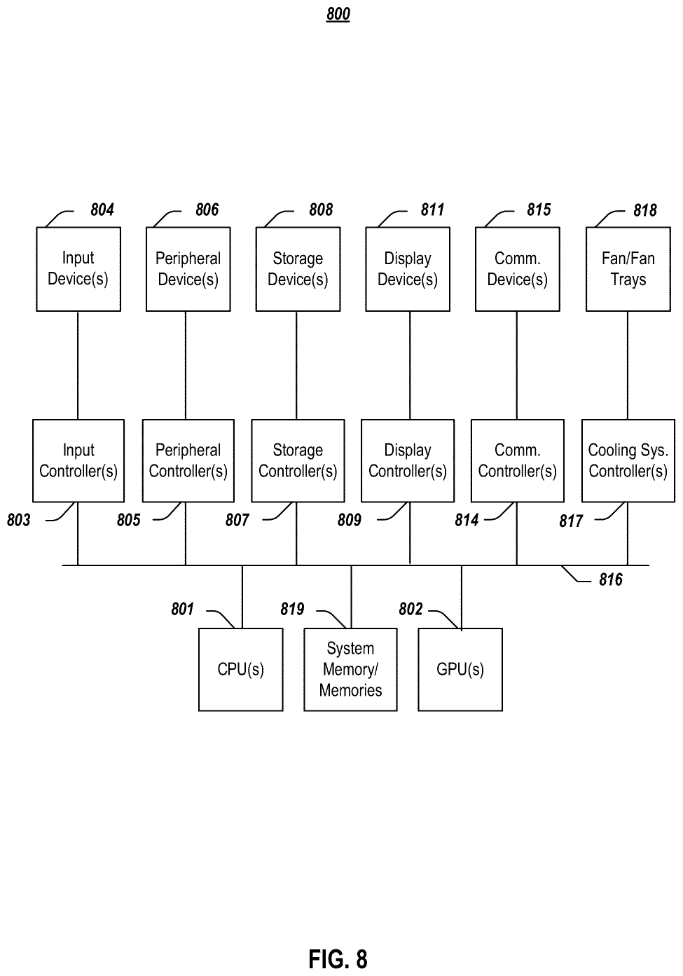

FIG. 8 depicts a simplified block diagram of an information handling system (or computing system), according to embodiments of the present disclosure. It will be understood that the functionalities shown for system 800 may operate to support various embodiments of a computing system—although it shall be understood that a computing system may be differently configured and include different components, including having fewer or more components as depicted in FIG. 8.

As illustrated in FIG. 8, the computing system 800 includes one or more CPUs 801 that provides computing resources and controls the computer. CPU 801 may be implemented with a microprocessor or the like, and may also include one or more graphics processing units (GPU) 802 and/or a floating-point coprocessor for mathematical computations. In one or more embodiments, one or more GPUs 802 may be incorporated within the display controller 809, such as part of a graphics card or cards. Thy system 800 may also include a system memory 819, which may comprise RAM, ROM, or both.

A number of controllers and peripheral devices may also be provided, as shown in FIG. 8. An input controller 803 represents an interface to various input device(s) 804. The computing system 800 may also include a storage controller 807 for interfacing with one or more storage devices 808 each of which includes a storage medium such as magnetic tape or disk, or an optical medium that might be used to record programs of instructions for operating systems, utilities, and applications, which may include embodiments of programs that implement various aspects of the present disclosure. Storage device(s) 808 may also be used to store processed data or data to be processed in accordance with the disclosure. The system 800 may also include a display controller 809 for providing an interface to a display device 811, which may be a cathode ray tube (CRT) display, a thin film transistor (TFT) display, organic light-emitting diode, electroluminescent panel, plasma panel, or any other type of display. The computing system 800 may also include one or more peripheral controllers or interfaces 805 for one or more peripherals 806. Examples of peripherals may include one or more printers, scanners, input devices, output devices, sensors, and the like. A communications controller 814 may interface with one or more communication devices 815, which enables the system 800 to connect to remote devices through any of a variety of networks including the Internet, a cloud resource (e.g., an Ethernet cloud, a Fiber Channel over Ethernet (FCoE)/Data Center Bridging (DCB) cloud, etc.), a local area network (LAN), a wide area network (WAN), a storage area network (SAN) or through any suitable electromagnetic carrier signals including infrared signals. As shown in the depicted embodiment, the computing system 800 comprises one or more fans or fan trays 818 and a cooling subsystem controller or controllers 817 that monitors thermal temperature(s) of the system 800 (or components thereof) and operates the fans/fan trays 818 to help regulate the temperature.

In the illustrated system, all major system components may connect to a bus 816, which may represent more than one physical bus. However, various system components may or may not be in physical proximity to one another. For example, input data and/or output data may be remotely transmitted from one physical location to another. In addition, programs that implement various aspects of the disclosure may be accessed from a remote location (e.g., a server) over a network. Such data and/or programs may be conveyed through any of a variety of machine-readable medium including, for example: magnetic media such as hard disks, floppy disks, and magnetic tape; optical media such as compact discs (CDs) and holographic devices; magneto-optical media; and hardware devices that are specially configured to store or to store and execute program code, such as application specific integrated circuits (ASICs), programmable logic devices (PLDs), flash memory devices, other non-volatile memory (NVM) devices (such as 3D XPoint-based devices), and ROM and RAM devices.

Aspects of the present disclosure may be encoded upon one or more non-transitory computer-readable media with instructions for one or more processors or processing units to cause steps to be performed. It shall be noted that the one or more non-transitory computer-readable media shall include volatile and/or non-volatile memory. It shall be noted that alternative implementations are possible, including a hardware implementation or a software/hardware implementation. Hardware-implemented functions may be realized using ASIC(s), programmable arrays, digital signal processing circuitry, or the like. Accordingly, the “means” terms in any claims are intended to cover both software and hardware implementations. Similarly, the term “computer-readable medium or media” as used herein includes software and/or hardware having a program of instructions embodied thereon, or a combination thereof. With these implementation alternatives in mind, it is to be understood that the figures and accompanying description provide the functional information one skilled in the art would require to write program code (i.e., software) and/or to fabricate circuits (i.e., hardware) to perform the processing required.

It shall be noted that embodiments of the present disclosure may further relate to computer products with a non-transitory, tangible computer-readable medium that have computer code thereon for performing various computer-implemented operations. The media and computer code may be those specially designed and constructed for the purposes of the present disclosure, or they may be of the kind known or available to those having skill in the relevant arts. Examples of tangible computer-readable media include, for example: magnetic media such as hard disks, floppy disks, and magnetic tape; optical media such as CDs and holographic devices; magneto-optical media; and hardware devices that are specially configured to store or to store and execute program code, such as ASICs, PLDs, flash memory devices, other non-volatile memory devices (such as 3D XPoint-based devices), and ROM and RAM devices. Examples of computer code include machine code, such as produced by a compiler, and files containing higher level code that are executed by a computer using an interpreter. Embodiments of the present disclosure may be implemented in whole or in part as machine-executable instructions that may be in program modules that are executed by a processing device. Examples of program modules include libraries, programs, routines, objects, components, and data structures. In distributed computing environments, program modules may be physically located in settings that are local, remote, or both.

One skilled in the art will recognize no computing system or programming language is critical to the practice of the present disclosure. One skilled in the art will also recognize that a number of the elements described above may be physically and/or functionally separated into modules and/or sub-modules or combined together.

It will be appreciated to those skilled in the art that the preceding examples and embodiments are exemplary and not limiting to the scope of the present disclosure. It is intended that all permutations, enhancements, equivalents, combinations, and improvements thereto that are apparent to those skilled in the art upon a reading of the specification and a study of the drawings are included within the true spirit and scope of the present disclosure. It shall also be noted that elements of any claims may be arranged differently including having multiple dependencies, configurations, and combinations.

1. A computer-implemented method for multi-model implementation comprising:
transforming, by a neural computing optimizer (NCO), each of multiple neural network models into a hardware-specific format that fits in a heterogeneous hardware platform;
establishing, a model tree for the transformed multiple neural network models to represent a collaborative relationship among the transformed multiple neural network models for implementation in the heterogeneous hardware platform;
mapping, by a neural computing accelerator (NCA), the model tree into the heterogeneous hardware platform for deployment; and
scheduling, by the NCA, one or more transformed neural network models for action using corresponding mapped resources in the heterogeneous hardware platform.

2. The computer-implemented method of claim 1 wherein the multiple neural network models are deep neural network (DNN) models.

3. The computer-implemented method of claim 1 wherein the DNN models are vision-based DNN models.

4. The computer-implemented method of claim 2 wherein the multiple neural network models are collaborative DNN models having a dependency, the collaborative DNN models comprise a first DNN model in a first hierarchical level and multiple DNN models in a second hierarchical level, any multiple DNN model in the second hierarchical level is executed after the first DNN model in the first hierarchical level.

5. The computer-implemented method of claim 4 wherein the heterogeneous hardware platform is an edge device comprising one or more central processing units (CPUs), one or more graphic processing units (GPUs), and multiple vision processing units (VPUs), each VPU comprises multiple cores.

6. The computer-implemented method of claim 5 wherein the first DNN model is deployed using the one or more CPUs and the one or more GPUs, the multiple DNN models in the second hierarchical level are deployed among a plurality of VPUs.

7. The computer-implemented method of claim 6 wherein the multiple DNN models in the second hierarchical level are deployed among the plurality of VPUs in a VPU allocation process comprising:
calculating a model parameter for each of the multiple DNN models in the second hierarchical level based on each model structure to obtain a model ratio among the multiple DNN models in the second hierarchical level; and
allocating, by the NCA, a plurality of VPUs or VPN partitions in the hardware platform among the among the multiple DNN models in the second hierarchical level according to the model ratio.

8. The computer-implemented method of claim 7 wherein the VPU allocation process comprising:
responsive to the allocated VPUs or VPU partitions being adequate for deployment of corresponding DNN models in the second hierarchical level, deploying the DNN models in the second hierarchical level to the allocated VPUs or VPU partitions for operation;
responsive to the allocated VPUs or VPU partitions being inadequate for deployment of corresponding DNN models in the second hierarchical level, partitioning one unallocated VPU in the hardware platform into multiple partitions with each partition comprising one or more cores and additionally allocating the multiple partitions among the DNN models in the second hierarchical level;
responsive to the allocated VPUs or VPU partitions together with the additionally allocated multiple partitions being adequate for deployment of corresponding DNN models in the second hierarchical level, deploying the DNN models in the second hierarchical level to the allocated VPUs and the allocated partitions for operation; and
responsive to the allocated VPUs or VPU partitions together with the additionally allocated multiple partitions being inadequate for deployment of corresponding DNN models in the second hierarchical level, adding one or more VPUs for resource allocation until all DNN models in the second hierarchical level fit within allocated resources.

9. The computer-implemented method of claim 8 wherein the one or more VPUs are added with or without core partitions.

10. A system for multi-model implementation comprising:
a neural computing optimizer (NCO) that transforms each of multiple neural network models into a hardware-specific format fitting in a heterogeneous hardware platform, the transformed multiple neural network models are represented in a model tree for a collaborative relationship for execution in the heterogeneous hardware platform; and
a neural computing accelerator (NCA) that maps the model tree into the heterogeneous hardware platform and schedules one or more transformed neural network models for operation in the heterogeneous hardware platform.

11. The system of claim 10 wherein the heterogeneous hardware platform is an edge device comprising one or more central processing units (CPUs), one or more graphic processing units (GPUs), and multiple vision processing units (VPUs), each VPU comprises multiple cores.

12. The system of claim 11 wherein the multiple neural network models are collaborative deep neural network (DNN) models having a dependency, the collaborative DNN models comprise a first DNN model in a first hierarchical level and multiple DNN models in a second hierarchical level, any multiple DNN model in the second hierarchical level is executed after the first DNN model in the first hierarchical level.

13. The system of claim 12 wherein the first DNN model is deployed using the one or more CPUs and the one or more GPUs, the multiple DNN models in the second hierarchical level are deployed among a plurality of VPUs.

14. The system of claim 12 wherein the multiple DNN models in the second hierarchical level are deployed among a plurality of VPUs in a VPU allocation process comprising:
calculating a model parameter for each of the multiple DNN models in the second hierarchical level based on each model structure to obtain a model ratio among the multiple DNN models in the second hierarchical level;
allocating, by the NCA, a plurality of VPUs or VPU partitions in the hardware platform among the among the multiple DNN models in the second hierarchical level according to the model ratio;
responsive to the allocated VPUs or VPU partitions being inadequate for deployment of corresponding DNN models in the second hierarchical level, partitioning one unallocated VPU in the hardware platform into multiple partitions with each partition comprising one or more cores and additionally allocating the multiple partitions among the DNN models in the second hierarchical level;
responsive to the allocated VPUs or VPU partitions together with the additionally allocated multiple partitions being adequate for deployment of corresponding DNN models in the second hierarchical level, deploying the DNN models in the second hierarchical level to the allocated VPUs and the allocated partitions for operation; and
responsive to the allocated VPUs or VPU partitions together with the additionally allocated multiple partitions being inadequate for deployment of corresponding DNN models in the second hierarchical level, adding one or more VPUs for resource allocation until all DNN models in the second hierarchical level fit within allocated resources.

15. The system of claim 10 wherein the NCO schedules the one or more transformed neural network models for operation in a route comprising multiple actions to implement a task pipeline.

16. A non-transitory computer-readable medium or media comprising one or more sequences of instructions which, when executed by at least one processor, causes steps for multi-model implementation comprising:
transforming, by a neural computing optimizer (NCO), each of multiple neural network models into a hardware-specific format that fits in a heterogeneous hardware platform;
establishing, a model tree for the transformed multiple neural network models to represent a collaborative relationship among the transformed multiple neural network models for implementation in the heterogeneous hardware platform;
mapping, by a neural computing accelerator (NCA), the model tree into the heterogeneous hardware platform for deployment; and
scheduling, by the NCA, one or more transformed neural network models for action using corresponding mapped resources in the heterogeneous hardware platform.

17. The non-transitory computer-readable medium or media of claim 16 wherein the heterogeneous hardware platform is an edge device comprising one or more central processing units (CPUs), one or more graphic processing units (GPUs), and multiple vision processing units (VPUs), each VPU comprises multiple cores.

18. The non-transitory computer-readable medium or media of claim 17 wherein the multiple neural network models are collaborative deep neural network (DNN) models having a dependency, the collaborative DNN models comprise a first DNN model in a first hierarchical level and multiple DNN models in a second hierarchical level, any multiple DNN model in the second hierarchical level is executed after the first DNN model in the first hierarchical level.

19. The non-transitory computer-readable medium or media of claim 18 wherein the first DNN model is deployed using the one or more CPUs and the one or more GPUs, the multiple DNN models in the second hierarchical level are deployed among a plurality of VPUs.

20. The non-transitory computer-readable medium or media of claim 19 wherein the multiple DNN models in the second hierarchical level are deployed among the plurality of VPUs in a VPU allocation process comprising:
calculating a model parameter for each of the multiple DNN models in the second hierarchical level based on each model structure to obtain a model ratio among the multiple DNN models in the second hierarchical level;
allocating, by the NCA, a plurality of VPUs or VPU partitions in the hardware platform among the among the multiple DNN models in the second hierarchical level according to the model ratio;
responsive to the allocated VPUs or VPU partitions being inadequate for deployment of corresponding DNN models in the second hierarchical level, partitioning one unallocated VPU in the hardware platform into multiple partitions with each partition comprising one or more cores and additionally allocating the multiple partitions among the DNN models in the second hierarchical level;
responsive to the allocated VPUs or VPU partitions together with the additionally allocated multiple partitions being adequate for deployment of corresponding DNN models in the second hierarchical level, deploying the DNN models in the second hierarchical level to the allocated VPUs and the allocated partitions for operation; and
responsive to the allocated VPUs or VPU partitions together with the additionally allocated multiple partitions being inadequate for deployment of corresponding DNN models in the second hierarchical level, adding one or more VPUs for resource allocation until all DNN models in the second hierarchical level fit within allocated resources.
